(19) United States
(12) Patent Application Publication
(10) Pub. No.: US 2011/0156620 A1
(43) Pub. Date: Jun. 30, 2011

(54) BATTERY PROTECTION SYSTEM AND METHOD THEREOF

(75) Inventor: CHIA-FU YEH, TAIPEI (TW)

(73) Assignee: SILITEK ELECTRONIC (GUANGZHOU) CO., LTD., GUANGZHOU (CN)

(21) Appl. No.: 12/732,443

(22) Filed: Mar. 26, 2010

(30) Foreign Application Priority Data
Dec. 25, 2009 (CN) 200910259771.1

(51) Int. Cl. H02J 7/14; H02P 3/14; H02H 7/18

(52) U.S. Cl. 318/139; 318/376; 307/10.7; 320/104; 320/119

(57) ABSTRACT

A battery protection method is provided for preventing a main battery set from being damaged by a current from a load, and for lengthening the lifespan of the main battery set. The method includes the steps of: providing an auxiliary battery set; determining whether to recycle energy of the load, and performing a charging mode if affirmative; and transferring energy from the load to the auxiliary battery set when performing the charging mode. The method prevents the main battery set from being damaged due to charging at a high C rate, transfers possible damage due to the high current charging to the auxiliary battery set, lengthens the lifespan of the main battery set, and reduces the overall cost and difficulty of the maintenance of the main battery set by shifting the focus of the maintenance from the main battery set to the auxiliary battery set.

### CROSS-REFERENCE TO RELATED APPLICATION

This application claims priority of Taiwanese Application No. 200910259771.1, filed on Dec. 25, 2009.

### BACKGROUND OF THE INVENTION

1. Field of the Invention

The present invention relates to a protection method and system, more particularly to a battery protection method and system.

2. Description of the Related Art

Driving range of electric vehicles can be greatly improved if the excess kinetic energy generated during braking is recycled and trans formed into electric energy to be stored in a battery set. Such process is called regenerative braking. Nevertheless, if the battery set is charged directly by a high current that is usually generated during the regenerative braking process of the electric vehicle (regenerative current), such high current will cause the battery set to be charged at an abnormally high C rate, which results in reversible and irreversible losses of capacity of the battery set. As a result, the lifespan of the battery set is shortened, and hence the battery set needs to be replaced frequently, which consequently increases the maintenance cost.

### SUMMARY OF THE INVENTION

Therefore, an object of the present invention is to provide a battery protection method for preventing a main battery set from being damaged when charged by a current from a load (regenerative current), and for lengthening the lifespan of the main battery set.

The battery protection method according to the present invention includes the steps of:

a) providing an auxiliary battery set;

b) determining whether to recycle energy of the load, and performing a charging mode if affirmative; and

c) transferring energy from the load to the auxiliary battery set while performing the charging mode.

Another object of the present invention is to provide a battery protection system adapted to be coupled between a load and a main battery set, and operable for preventing the main battery set from being damaged by an induced current from the load (regenerative current), and for lengthening the lifespan of the main battery set. The battery protection system includes:

an auxiliary battery set capable of charging and discharging;

a first switch for coupling the auxiliary battery set to the load;

a first voltage converter adapted to be coupled to the main battery set and operable for converting a voltage received thereby into a charging current;

a second switch coupled between the auxiliary battery set and the first voltage converter; and

a control circuit coupled to the first and second switches for controlling opening and closing of the first and second switches, the control circuit being operable in a charging mode and a discharging mode;

wherein, when the control circuit operates in the charging mode, the control circuit controls the first switch such that the current from the load is able to charge the auxiliary battery set, thereby transferring energy from the load to the auxiliary battery set; and

wherein, when the control circuit operates in the discharging mode, the control circuit closes the second switch such that the charging current from the first voltage converter is able to charge the main battery set, thereby transferring energy from the auxiliary battery set to the main battery set.

The present invention prevents a high regenerative current from a load from causing damage to a main battery set when the regenerative current charges the main battery set. The present invention further charges the main battery set with a trickle current when the main battery set is in an idle state so as to simultaneously charge and maintain the main battery set.

### BRIEF DESCRIPTION OF THE DRAWINGS

Other features and advantages of the present invention will become apparent in the following detailed description of the preferred embodiment with reference to the accompanying drawings, of which:

FIG. 1 is a circuit block diagram illustrating the preferred embodiment of the present invention when performing a charging mode;

FIG. 2 is a flowchart of the preferred embodiment of the present invention;

FIG. 3 is a circuit block diagram of the preferred embodiment when performing a discharging mode; and

FIG. 4 is a circuit block diagram of the preferred embodiment when performing a balancing mode.

### DETAILED DESCRIPTION OF THE PREFERRED EMBODIMENT

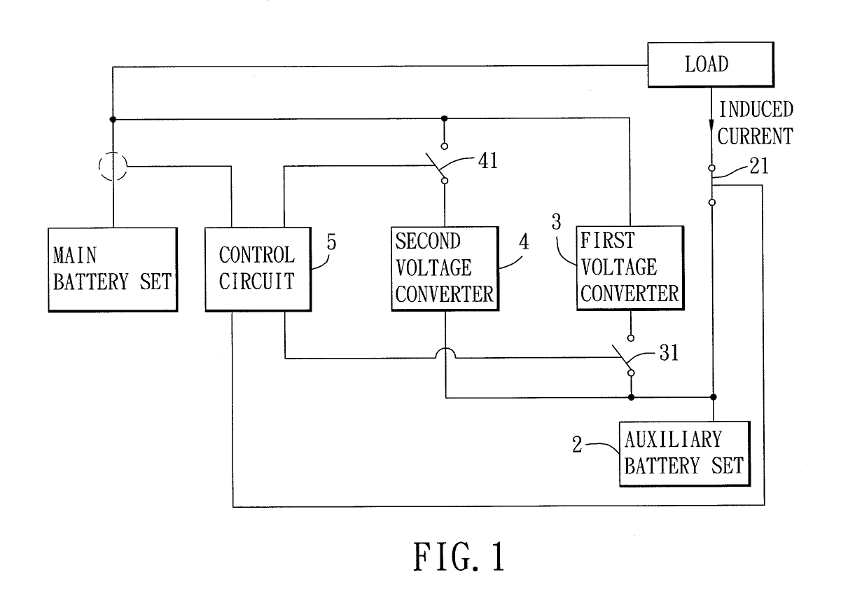

As shown in FIG. 1, the preferred embodiment of a battery protection system according to the present invention is adapted to be coupled between a main battery set having a plurality of batteries and a set of input/output (I/O) terminals, and a load. The battery protection system is operable in a discharging mode, a charging mode, and a balancing mode. The battery protection system is for preventing a high current from the load (regenerative current) from damaging the main battery set, and for lengthening the lifespan of the main battery set. Furthermore, in the present embodiment, the load is a motor capable of accelerating and decelerating and suitable for use in electric vehicles having regenerative motors. The battery protection system comprises: an auxiliary battery set 2, a first switch 21, a first voltage converter 3, a second switch 31, a second voltage converter 4, a third switch 41, and a control circuit 5.

The auxiliary battery set 2 is capable of charging and discharging, and includes a set of input/output (I/O) terminals.

The first switch 21 is electrically connected between the load and the I/O terminal of the auxiliary battery set 2, and is controlled to switch between open (non-conducting) and closed (conducting) states.

The first voltage converter 3 has an output terminal electrically connected to the I/O terminal of the main battery set, and an input terminal. The first voltage converter 3 is for converting a voltage received by the input terminal thereof to provide a charging current.

The second switch 31 is electrically connected between the I/O terminal of the auxiliary battery set 2 and the input terminal of the first voltage converter 3. The second switch 31 is controlled to switch between open (non-conducting) and closed (conducting) states.

The second voltage converter 4 has an output terminal electrically connected to the I/O terminal of the auxiliary battery set 2, and an input terminal. The second voltage converter 4 is for converting a voltage received by the input terminal thereof.

The third switch 41 is electrically connected between the I/O terminal of the main battery set and the input terminal of the second voltage converter 4.

Based on an external command, or via detecting the condition of the supplying of power by the main battery set to the load, the control circuit 5 causes the battery protection system to perform a battery protection method.

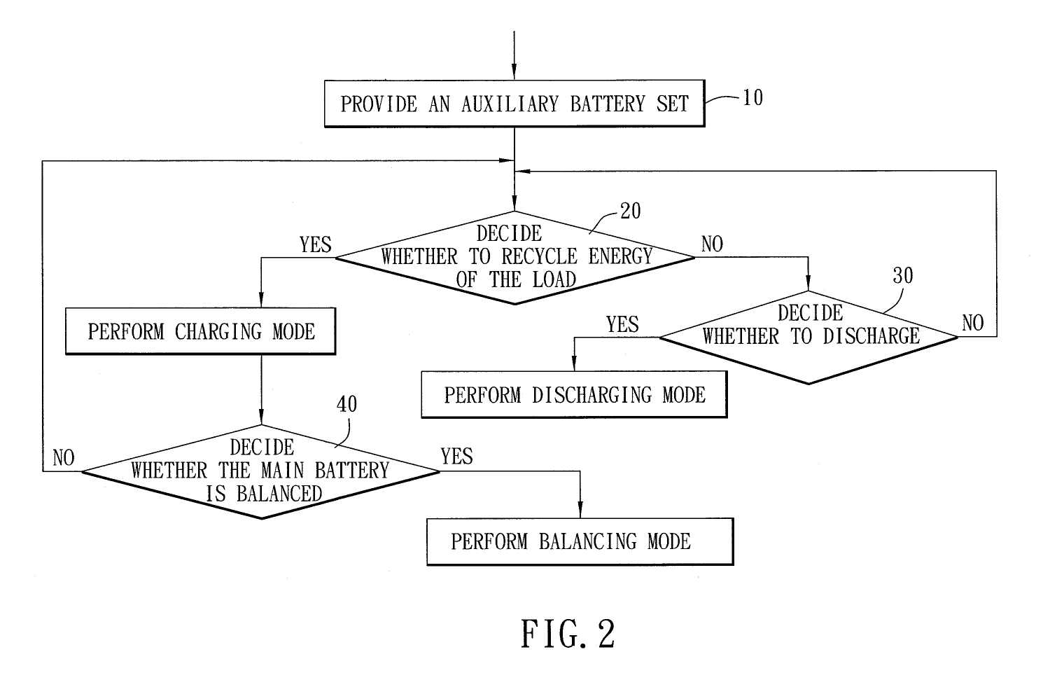

As shown in FIG. 2, the battery protection method comprises the steps of:

10) providing an auxiliary battery set 2;

20) determining whether to recycle energy of the load, operating in a charging mode if affirmative, and proceed to step 30 if otherwise; and

30) determining whether to operate in a discharging mode, performing the discharging mode if affirmative, and returning to step 20) if otherwise.

In step 20), the control circuit 5 operates in the charging mode when it is detected that the motor performs braking and generates recyclable energy.

### Charging Mode:

As shown in FIG. 1, when the main battery set provides electricity to the load, and the load generates an induced current, the control circuit 5 will perform the charging mode, and will control the first switch 21 such that the induced current is able to charge the auxiliary battery set 2 via the first switch 21, thereby the energy of the load to be recycled is transferred to the auxiliary battery set 2.

By arranging the auxiliary battery set 2 to serve as a buffer between the load and the main battery set, possible damage due to the induced current from the load is transferred from the main battery set to the auxiliary battery set 2, thereby preventing the induced current from damaging the main battery set when the magnitude of the induced current is large.

### Discharging Mode:

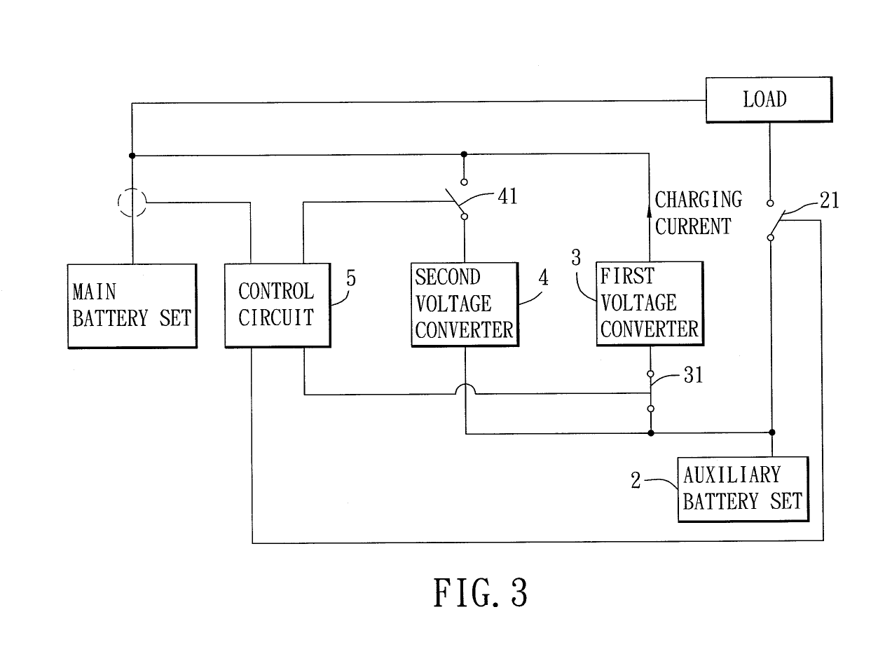

As shown in FIG. 3, when the main battery set is not providing energy to the load and is in an idle state, the control circuit 5 will perform the discharging mode in which the control circuit 5 controls the first and third switches 21, 41 to open, and the second switch 31 to close so as to electrically connect the input terminal of the first voltage converter 3 and the I/O terminal of the auxiliary battery set 2.

In the meantime, the first voltage converter 3 will convert the output voltage of the auxiliary battery set 2 to conform with the input voltage of the main battery set and will generate a charging current for charging the main battery set, thereby transferring energy of the auxiliary battery set 2 to the main battery set, wherein the charging current has a magnitude such that the main battery set is charged by a trickle current.

Moreover, in the present embodiment, the first voltage converter 3 is a boost DC-DC converter for boosting the output voltage of the auxiliary battery set 2 to conform with the input voltage of the main battery set.

It is to be noted that the full charge capacity (FCC) of the main battery set decreases with an increase in the number of uses. The decrease in the FCC includes an irreversible loss and a reversible loss. The irreversible loss is caused by wearing of active material, and hence cannot be recovered. The reversible loss is caused by improper charging and discharging processes (e.g., high-current discharging and high-current charging), which causes the arrangement of the active material in the battery to be irregular, and subsequently lessens the amount of reusable active material. By virtue of trickle charging, the active material in the battery is given enough time to be rearranged regularly during the migration, thereby reducing the reversible loss, slowing down the aging process of the battery, and lengthening the lifespan of the main battery set.

The battery protection method further comprises the step of

40) determining whether to perform a balancing mode, operating in the balancing mode if affirmative, and returning to step 20) if otherwise.

### Balancing Mode:

The main battery set includes a plurality of batteries. Because the batteries may have different charging and discharging capacities, charging conversion efficiencies, and initial capacities, the voltages of the batteries will be different after repeated charging and discharging processes. At this time, it is required to balance the batteries. The control circuit 5 detects voltage of each of the batteries, and compares the voltage of each of the batteries with a reference voltage, thereby determining if the voltage of any of the batteries is higher than the reference voltage. If affirmative, the control circuit 5 will perform the balancing mode. Besides, the control circuit 5 can also be controlled to perform the balancing mode based on an external command.

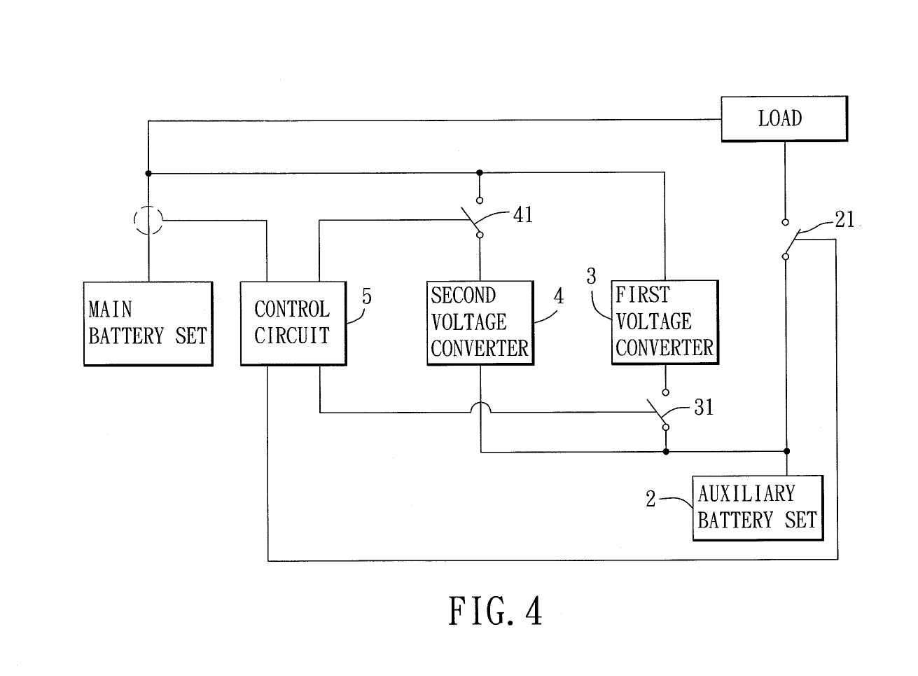

As shown in FIG. 4, while performing in the balancing mode, the control circuit 5 will control the first and second switches 21, 31 to open, and the third switch 41 to close so as to electrically connect the I/O terminal of the main battery set and the input terminal of the second voltage converter 4. Subsequently, the second voltage converter 4 converts the output voltage of the main battery set to conform with the input voltage of the auxiliary battery set 2 so as to transfer energy of batteries of the main battery set, that have voltages higher than the reference voltage, to the auxiliary battery set 2. The transfer of energy continues until the voltages of the batteries are all equal to the reference voltage, i.e., the voltages of the batteries of the main battery set are balanced, thereby preventing the main battery set from being damaged due to over-charging or over-discharging (or even explosion) during subsequent charging and discharging processes.

Furthermore, in the present embodiment, the second voltage converter 4 is a buck DC-DC converter for bucking the output voltage of the main battery set to conform with the input voltage of the auxiliary battery set 2.

In summary, the present invention has the following advantages.

First, the present invention achieves the effects of charging and maintaining the main battery set by trickle charging the main battery set using the auxiliary battery set 2.

Second, the auxiliary battery set 2 is arranged to serve as a buffer between the load and the main battery set such that the auxiliary battery set 2 is charged by an induced current from the load, generates a charging current having a relatively small magnitude (trickle current), and provides the charging current to the main battery set. Therefore, the arrangement of the auxiliary battery set 2 prevents the induced current from the load, which has a relatively large magnitude, from causing damage to the main battery set, and transfers the possible damage due to the induced current from the main battery set to the auxiliary battery set 2. Hence, the present invention can slow down the ageing process of the main battery set. Moreover, since the cost and the difficulty of maintenance of the auxiliary battery set 2 are lower and easier than those of the main battery set, the present invention reduces the overall cost and the difficulty of the maintenance of the main battery set by shifting the focus of the maintenance from the main battery set to the auxiliary battery set 2.

Third, the control circuit 5 of the present invention transfers energy of batteries of the main battery set, that have relatively higher voltages, to the auxiliary battery set 2 so as to balance the voltages of the batteries.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A battery protection method for preventing a main battery set from being damaged by a current from a load, and for lengthening the lifespan of the main battery set, comprising the steps of:
a) providing an auxiliary battery set;
b) determining whether to recycle energy of the load, and performing a charging mode if affirmative; and
c) transferring energy from the load to the auxiliary battery set when performing the charging mode.

2. The battery protection method as claimed in claim 1, the load being a motor capable of accelerating and decelerating, wherein performing of the charging mode is enabled when it is detected in step b) that the motor is decelerating and generates recyclable energy.

3. The battery protection method as claimed in claim 1, wherein, in step c), the auxiliary battery set is charged by the current flow from the load when performing the charging mode.

4. The battery protection method as claimed in claim 1, further comprising the steps of:
d) when it is determined in step b) that the energy of the load is not to be recycled, further determining whether to perform a discharging mode; and
e) transferring energy from the auxiliary battery set to the main battery set when performing the discharging mode.

5. The battery protection method as claimed in claim 4, wherein performing of the discharging mode is enabled when it is detected in step d) that the main battery set is not providing energy to the load and is in an idle state.

6. The battery protection method as claimed in claim 4, wherein the output voltage of the auxiliary battery set is converted to conform with an input voltage of the main battery set in step e).

7. The battery protection method as claimed in claim 6, wherein, in step e), the auxiliary battery set generates a charging current for charging the main battery set.

8. The battery protection method as claimed in claim 7, wherein, in step e), the charging current has a magnitude such that the main battery set is charged by a trickle current.

9. The battery protection method as claimed in claim 1, further comprising the steps of:
f) determining whether to perform a balancing mode; and
g) transferring energy from the main battery set to the auxiliary battery set when performing the balancing mode.

10. The battery protection method as claimed in claim 9, wherein the output voltage of the main battery set is converted to conform with an input voltage of the auxiliary battery set in step g).

11. The battery protection method as claimed in claim 9, the main battery set including a plurality of batteries, wherein step f) includes:
f1) detecting a voltage of each of the batteries of the main battery set;
f2) comparing the voltage of each of the batteries of the main battery set with a reference voltage; and
f3) performing the balancing mode when the voltage of anyone of the batteries is higher than the reference voltage so as to transfer the energy of said any one of the batteries to the auxiliary battery set.

12. A battery protection system adapted to be coupled between a load and a main battery set, said battery protection system being for preventing the main battery set from being damaged by a current from the load, and for lengthening the lifespan of the main battery set, said battery protection system comprising:
an auxiliary battery set capable of charging and discharging;
a first switch for coupling said auxiliary battery set to the load;
a first voltage converter adapted to be coupled to the main battery set and operable for converting a voltage received thereby to provide a charging current;
a second switch coupled between said auxiliary battery set and said first voltage converter; and
a control circuit coupled to said first and second switches for controlling opening and closing of said first and second switches, said control circuit being operable in a charging mode and a discharging mode;
wherein, when said control circuit performs the charging mode, said control circuit controls said first switch such that the induced current from the load is able to charge said auxiliary battery set, thereby transferring energy from the load to said auxiliary battery set; and
wherein, when said control circuit performs the discharging mode, said control circuit controls said second switch such that the charging current from said first voltage converter is able to charge the main battery set, thereby transferring energy from said auxiliary battery set to the main battery set.

13. The battery protection system as claimed in claim 12, wherein the charging current has a magnitude such that the main battery set is charged by a trickle charge.

14. The battery protection system as claimed in claim 12, further comprising:
a second voltage converter coupled to said auxiliary battery set; and
a third switch for coupling said second voltage converter to the main battery set;
said control circuit being further coupled to said third switch for controlling opening and closing of said third switch, and being further operable in a balancing mode;
wherein, when said control circuit performs the balancing mode, said control circuit closes said third switch such that output voltage of the main battery set is converted by said second voltage converter to conform with an input voltage of said auxiliary battery set, and such that the energy from the main battery set is transferred to said auxiliary battery set.

15. The battery protection system as claimed in claim 14, the main battery set including a plurality of batteries, wherein said control circuit further detects voltage of each of the batteries of the main battery set, compares the voltage of each of the batteries of the main battery set with a reference voltage, and performs the balancing mode when the voltage of any one of the batteries is higher than the reference voltage so as to transfer the energy of said any one of the batteries to the auxiliary battery set.
